(19) United States
(12) Patent Application Publication
(10) Pub. No.: US 2015/0242202 A1
(43) Pub. Date: Aug. 27, 2015

(54) METHOD OF UPDATING FIRMWARE OF MEMORY DEVICE INCLUDING MEMORY AND CONTROLLER

(71) Applicant: Samsung Electronics Co., Ltd., Suwon-si (KR)

(72) Inventors: Walter JUN, Seoul (KR); Joon-ho LEE, Hwaseong-si (KR)

(21) Appl. No.: 14/628,632

(22) Filed: Feb. 23, 2015

(30) Foreign Application Priority Data
Feb. 24, 2014 (KR) 10-2014-0021420

(51) Int. Cl. G06F 9/445

(52) U.S. Cl. CPC G06F 8/665; G06F 8/67

(57) ABSTRACT

Provided is a method of updating firmware of a memory device including a memory and a controller driving firmware to control the memory. The method includes updating the firmware of the memory device by transmitting at least one normal command and an address corresponding to the at least one normal command to the memory device. The normal command is a command to issue a normal operation, and the normal operation is not an update operation of the firmware.

### CROSS-REFERENCE TO RELATED APPLICATIONS

This US non-provisional patent application claims priority under 35 USC §119 to Korean Patent Application No. 10-2014-0021420, filed on Feb. 24, 2014, the entirety of which is hereby incorporated by reference.

### BACKGROUND

One or more example embodiments of the inventive concepts relate to semiconductor memories and, more particularly, to a method of updating firmware of a memory device including a memory and a controller.

Semiconductor memory devices are memory devices implemented using semiconductors such as silicon (Si), germanium (Ge), gallium arsenide (GaAs), and indium phosphide (InP). In general, semiconductor memory devices are classified into volatile memory devices and nonvolatile memory devices.

Volatile memory devices lose their stored data when their power supplies are interrupted. Volatile memory devices include types of random access memory (RAM) including a static RAM (SRAM), a dynamic RAM (DRAM), a synchronous DRAM (SDRAM), and the like. Nonvolatile memory devices retain their stored data even when their power supplies are interrupted. Nonvolatile memory devices include a read only memory (ROM), a programmable ROM (PROM), an electrically programmable ROM (EPROM), an electrically erasable and programmable ROM (EEPROM), a flash memory, a phase-change RAM (PRAM), a resistive RAM (RRAM), a ferroelectric RAM (FRAM), and the like.

### SUMMARY

The present disclosure provides a method of operating a memory device including a memory and/or a controller with improved operating performance.

According to one or more example embodiments of the inventive concepts, a method of updating firmware of a memory device including a memory and a controller driving firmware to control the memory includes updating the firmware of the memory device by transmitting at least one normal command and an address corresponding to the at least one normal command to the memory device, wherein the normal command is a command to issue a normal operation, and wherein the normal operation is not an update operation of the firmware.

The normal command may be a read or write command, and the normal operation is a read or write operation depending on the read or write command.

The address may have a value corresponding to a rule for updating the firmware.

The updating the firmware of the memory device may include transmitting a first normal command and a first address to the memory device, the first normal command and the first address corresponding to a request for the memory device to download update data; and transmitting a second normal command and a second address to the memory device, the second normal command and the second address corresponding to a request for the memory device to update the firmware.

The updating the firmware of the memory device may further include transmitting a third normal command and a third address to the memory device, the third normal command and the third address corresponding to a request for the memory device to confirm that the first normal command and the first address were properly received by the memory device; and transmitting a fourth normal command and a fourth address to the memory device, the fourth normal command and the fourth address corresponding to a request for the memory device to confirm that the second normal command and the second address were properly received by the memory device.

The updating the firmware of the memory device may further include transmitting a third normal command and a third address to the memory device together with the update data, the third normal command and the third address corresponding to a request for the memory device to start downloading the update data; and transmitting a forth normal command and a fourth address to the memory device, the fourth normal command and the fourth address corresponding to a request for the memory device to start updating the firmware.

The method may further include transmitting a second normal command and a second address to the memory device, the second normal command and the second address corresponding to a request for the memory device to send information regarding an update progress status of the firmware.

According to one or more example embodiments of the inventive concepts, a method of updating firmware of a memory device including a memory and a controller driving firmware to control the memory includes receiving, at the memory device, at least one normal command and an address corresponding to the at least one normal command of the memory device; updating the firmware in response to the memory device receiving the at least one normal command and the address, wherein the normal command is a command to perform a normal operation, and wherein the normal operation is not an operation of updating the firmware.

The updating firmware may include storing update data of the firmware in a buffer memory of the memory device; and updating the firmware using the update data stored in the buffer memory.

The updating the firmware may include storing update data of the firmware in a memory block of the memory through a buffer memory of the memory device; and updating the firmware using the update data stored in the memory block.

The memory block may be a block allocated to store the update data, and the memory block may not store user data.

The memory block may be a free block among a plurality of memory blocks, the plurality of memory blocks being designated for storing user data.

The firmware may be stored in at least two memory blocks among a plurality of memory blocks of the memory, the at least two memory blocks being blocks that do not store user data.

The updating the firmware may include erasing the at least two memory blocks; and writing update data of the firmware into the at least two of the memory blocks.

The method may further include rebooting the memory device after update of the firmware is completed.

According to one or more example embodiments of the inventive concepts, a method of updating firmware of a memory device including a memory and a controller that executes firmware to control the memory device may include receiving, at the memory device, at least one first command and a first address corresponding to the at least one first command, the first command having a format for instructing the memory device to perform a first operation; determining whether the at least one first command and the first address satisfy one of a plurality of rules; when the at least one first command and the first address satisfy one of the plurality of rules, performing, in response to receiving the at least one first command and the first address, a firmware update operation instead of performing the first operation, the firmware update operation including updating the firmware of the memory device, the first operation being different from the firmware update operation.

The method may further include storing, in the memory device, rules information defining the first plurality of rules, the rules information indicating one or more addresses, wherein the determining includes, performing a comparison operation based on the first address and the one or more addresses indicated by the rules information, and determining whether the at least one first command and the first address satisfy one of a plurality of rules based on the comparison.

The first operation may be a read operation for instructing the memory device to read information from a location in the memory device that is specified by an address sent with the at least one first command, or the first operation may be a write operation for instructing the memory device to write information at a location in the memory device that is specified by an address sent with the at least one first command.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram of a computing device according to at least one example embodiment of the inventive concepts;

FIG. 2 is a block diagram of a software hierarchy of a computing system accessing a memory or an external memory;

FIG. 3 is a block diagram of a computing device according to at least one example embodiment of the inventive concepts;

FIG. 4 is a block diagram of a memory according to at least one example embodiment of the inventive concepts;

FIG. 5 is a flowchart summarizing a method of updating firmware of a memory according to at least one example embodiment of the inventive concepts;

FIG. 6 is a table showing an example of a rule of a normal command and an address for updating firmware of a memory;

FIG. 7 is a flowchart summarizing the operation of a host when firmware update is performed;

FIG. 8 is a flowchart summarizing the operation of a memory when firmware update is performed;

FIG. 9 is a flowchart summarizing a method of performing a download function of firmware;

FIG. 10 illustrates an example where a memory stores update data when a download function is performed;

FIG. 11 illustrates another example where a memory stores update data when a download function is performed;

FIG. 12 is a flowchart summarizing a method of performing a update function;

FIG. 13 illustrates an example where a memory updates firmware when an update function is performed;

FIG. 14 illustrates another example where a memory updates firmware when an update function is performed;

FIG. 15 illustrates another example where a memory updates firmware when an update function is performed;

FIG. 16 is a flowchart summarizing a method of performing a state check function; and

FIG. 17 is a block diagram of a software layer according to at least one example embodiment of the inventive concepts.

### DETAILED DESCRIPTION

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

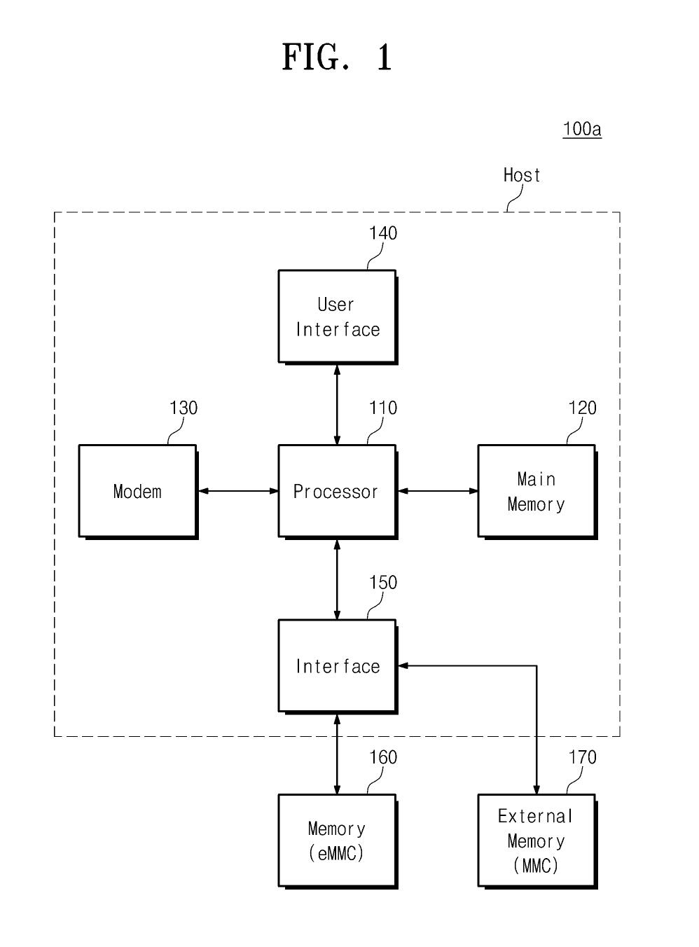

FIG. 1 is a block diagram of a computing device 100a according to at least one example embodiment of the inventive concepts. As illustrated, the computing device 100a includes a processor 110, a main memory 120, a modem 130, a user interface 140, an interface 150, a memory 160, and an external memory 170.

The processor 110 may control the overall operation of the computing device 100a and performs a logical operation. For example, the processor 110 may include a system-on-chip (SoC). The processor 110 may include a general-purpose processor programmed to perform specific operations, a specific-purpose processor or the like. The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multiprocessor, an application-specific integrated circuit (ASIC), and a field programmable gate array (FPGA), any of which may be implemented as the above-referenced SoC.

The main memory 120 may be a working memory of the processor 110. The main memory 120 may store codes and data driven by the processor 110. The main memory 120 may be random access memory (RAM). The main memory 120 may include a volatile RAM such as dynamic RAM (DRAM), static RAM (SRAM), and synchronous DRAM (SDRAM). The main memory 120 may include a nonvolatile RAM such as ferroelectric RAM (FRAM), phase-change RAM (PRAM), magneto-resistive RAM (MRAM), and resistive RAM (RRAM).

The modem 130 may be a circuit that communicates with an external device according to the control of the processor 110. For example, the modem 130 may perform communication based on at least one of various wireless communication schemes example of which include long term evolution (LTE), WiMax, global system for mobile communication (GSM), code division multiple access (CDMA), Bluetooth, near field communication (NFC), WiFi, and radio frequency identification (RFID). According to one or more example embodiments of the inventive concepts, the modem 130 and the processor 110 may be integrated into a single semiconductor integrated circuit (IC).

The user interface 140 may be a circuit that communicates with a user according to the control of the processor 110. For example, the user interface 140 may include user input interfaces examples of which include a keyboard, a keypad, a button, a touch panel, a touch screen, a touch pad, a touch ball, a camera, a microphone, a gyroscope sensor, and a vibration sensor. The user interface 140 may include user output interfaces examples of which include a liquid crystal display (LCD), an organic light emitting diode (OLED) display, an active matrix OLED (AMOLED), an LED, a speaker, and a monitor.

The interface 150 may be a circuit that mediates communication between the processor 110 and storage devices.

The memory 160 may communicate with the processor 110 through the interface 150. The memory 160 may be accessed by the processor 110. The memory 160 may include a nonvolatile memory. The memory 160 may include an embedded multimedia card (eMMC).

The external memory 170 may communicate with the processor 110 through the interface 150. The external memory 170 may be accessed by the processor 110. The external memory 170 may be a removable nonvolatile memory. The memory 170 may include a multimedia card (MMC).

According to one or more example embodiments of the inventive concepts, the computing device 100a may be a portable smart multimedia device such as a smartphone and a smart tablet.

The processor 110, the main memory 120, the modem 130, the user interface 140, and the interface 150 may act as a host of the memory 160 or the external memory 170.

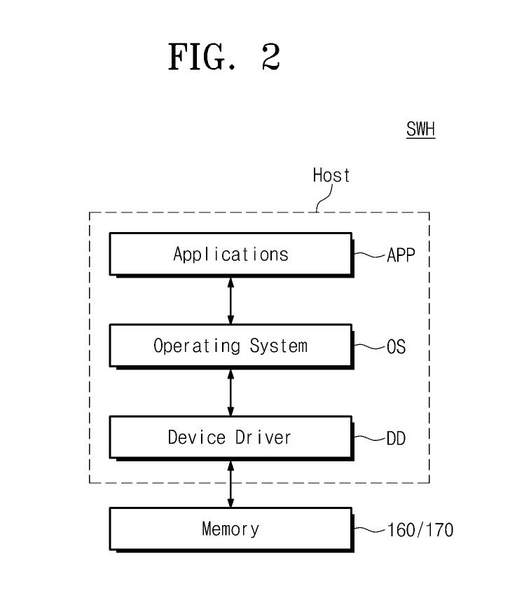

FIG. 2 is a block diagram of a software hierarchy SWH of the computing system 100a accessing a memory or an external memory 160/170. Referring to FIGS. 1 and 2, the software hierarchy SWH includes applications APP, an operating system OS, a device driver DD, and the memory 160/170.

The applications APP may be driven by the processor 110. The applications APP may be driven on the operating system OS. The applications APP may access the memory 160/170 according to requests of users (e.g., users of the computing device 100a) or according to a predetermined or, alternatively, desired schedule based on resources (e.g., memory capacity, computing power, etc.) allocated by the operating system OS.

The applications APP may include various types of software for performing various purposes. The applications APP may include, for example, any or all of a word processor, spread sheet, database, and software for producing and playing multimedia contents. The applications APP may include software for supporting efficient management of the memory 160/170.

The operating system OS may be driven by the processor 110. The operating system OS may manage resources (e.g., memory capacity, computing power, etc.) of the computing system 100a. The operating system OS may allocate the resources (e.g., memory capacity, computing power, etc.) to the applications APP. The operating system OS may access hardware of the computing device 100a according to requests of the applications APP.

The device driver DD may convert a hardware access request issued by the operating system OS into a command that can be identified by hardware. According to one or more example embodiments of the inventive concepts, the operating system OS may issue a logical command to manage resources and the device driver DD may convert the logical command issued by the operating system OS into a physical command. For example, the device-driver may translate commands issued by the OS from a first command format to a machine-level command format readable by one or more of the circuits included in the computing device 100a.

The memory 160/170 may be accessed by a command transmitted from the device driver DD.

The applications APP, the operating system OS, and the device driver DD may belong to, operated by, or viewed as a host of the memory 160/170.

In some conventional smart multimedia devices, an operating system OS does not grant root privilege to applications APP. That is, the applications APP may not be able to directly access components of the computing device 100a. The applications APP may only be able to access resources distributed by the operating system OS only using an authority that the operating system OS grants.

If the root privilege is not granted to the applications APP, the applications APP cannot use a special operation even when the special operation is provided to the memory 160. Vendor specific commands, which will be discussed in greater detail below, are an example of a special operation.

According to one or more example embodiments of the inventive concepts, the memory 160/170 may support a firmware update. The memory 160/170 may support a command for the firmware update. For example, the memory 160/170 may be fabricated according to a specification of a secure digital (SD) card. The specification of the SD card allows a vendor specific command other than a normal command. The normal command may include a read command and a write command to issue conventionally used operations such as a read operation and a write operation. The vendor specific command is a command whose operation may be defined by a vendor. For example, the firmware update command may be supported as a vendor specific command.

When the firmware update of the memory 160/170 is allowed during a normal operation of the computing device 100a, operating performance of the computing device 100a may be enhanced due to an easy firmware update. For example, the firmware update is performed by the applications APP, and the operating performance of the computing device 100a may be enhanced.

However, when an operating system OS driven in the computing device 100a does not grant root privilege to the applications APP, the applications APP may be only allowed to issue normal commands such as read and write commands, but may not be allowed to issue a specific command relating to a special operation such as the firmware update command.

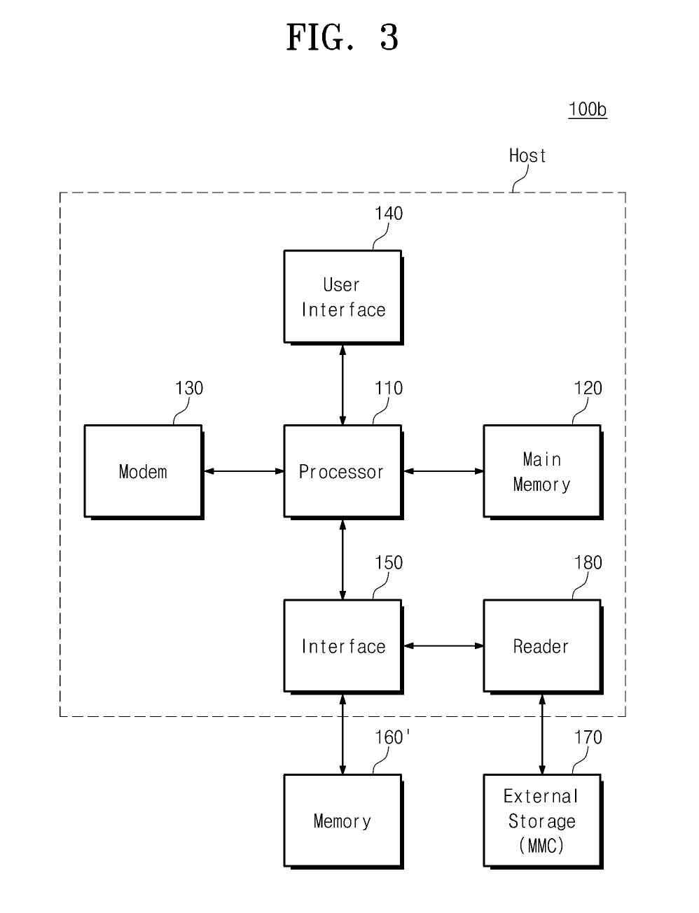

FIG. 3 is a block diagram of a computing device 100b according to another embodiment of the inventive concept. As illustrated, the computing device 100b includes a processor 110, a main memory 120, a modem 130, a user interface 140, an interface 150, a memory 160′, an external storage 170, and a reader 180.

As compared to the computing device 100a in FIG. 1, the computing device 100b further includes the reader 180. Accordingly, the computing device 100b may have the same structure as that described above with respect to the computing device 100a, with the exception of the addition of the reader 180. The reader 180 may communicate with the processor 110 through the interface 150. The reader 180 may control the external memory 170 according to a control of the processor 110. The memory 160′ of the computing device 110b may include a mass nonvolatile storage device such as a hard disk drive (HDD) and a solid state drive (SSD). The computing device 100b may be a general-purpose computer such as a personal computer (PC) and a laptop computer, which is programmed to operate in s specific manner, thereby making the general-purpose computer a specific-purpose computer.

The processor 110, the main memory 120, the modem 130, the user interface 140, the interface 150, and the reader 180 may act as a host of the external memory 170.

According to one or more example embodiments of the inventive concepts, a software hierarchy of the computing device 100b may be identical to the software hierarchy SWH shown in FIG. 2. According to one or more example embodiments of the inventive concepts, referring to FIGS. 2 and 3, if the computing device 100b is a personal computer (PC) or a laptop computer, an operating system (OS) may grant root privilege to applications APP. However, if the computing device 100b is a personal computer (PC) or a laptop computer, the external memory 170 such as MMC is connected to a host through the reader 180.

The reader 180 communicates with the interface 150 according to a predetermined or, alternatively, desired protocol. For example, the reader 180 may communicate with the interface 150 according to a USB protocol. However, the USB protocol may only supports a function to issue normal commands such as a write command and a read command, but may not support a function to issue a vendor specific command (e.g., a firmware update command) supported by the external memory 170. Thus, when the external memory 170 is connected to the interface 150 through the reader 180, the applications APP cannot perform firmware update even though the firmware update is supported by the external memory 170.

As described with reference to FIG. 1, an operating system (OS) of the computing device 100a such as a smart multimedia device may not grant root privilege to the applications APP. In this case, although firmware update is provided to the memory 160/170 such as MMC and eMMC, the applications APP may not be able to issue a firmware update command to execute the firmware update. Similarly, as described with reference to FIG. 3, when the memory 170 is connected to the host through the reader 180, the applications APP may not be able issue a firmware update command to execute the firmware update although the firmware update is provided to a memory such as MMC and eMMC.

In order to overcome the above-referenced disadvantage, the computing device 100a or 100b according to at least one example embodiment of the inventive concepts may issue firmware update using a normal command and an address. For example, applications APP driven in the computing device 100a or 100b may select a normal command and an address corresponding to firmware update according to a predetermined or, alternatively, desired rule. The applications APP may issue the firmware update to the memory 160/170 by issuing the selected normal command and the selected address.

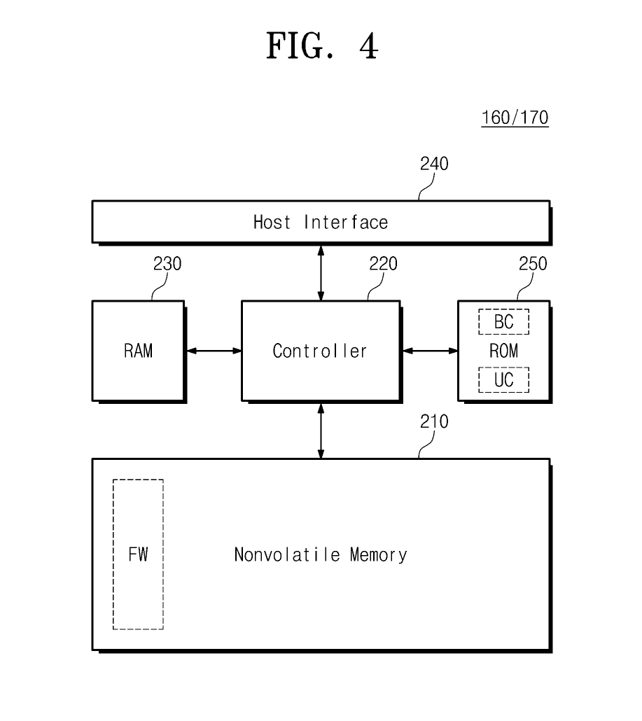

FIG. 4 is a block diagram of a memory 160/170 according to at least one example embodiment of the inventive concepts. According to one or more example embodiments of the inventive concepts, the memory 160/170 may be the memory 160 described with reference to FIG. 1, i.e., an eMMC. Alternatively, the memory 160/170 may be the external memory 170 described with reference to FIGS. 1 and 3, i.e., an MMC. Referring to FIG. 4, the memory 160/170 includes a nonvolatile memory 210, a controller 220, a random access memory 230, a host interface 240, and a read only memory (ROM) 250.

The nonvolatile memory 210 may include a flash memory, an FRAM, a PRAM, an MRAM, a PRAM, an EEPROM, and the like. The nonvolatile memory 210 may store firmware FW.

The controller 220 may be a circuit that controls the operations of the nonvolatile memory 210. The controller 220 may access the nonvolatile memory 210 in response to a command and an address received through the host interface 240. The controller 220 may read firmware FW from the nonvolatile memory 210 and drive the read firmware FW. The firmware FW driven by the controller 220 may process a request of a host and control overall operations of the memory 160/170.

The random access memory 230 may be a working memory of the controller 220. The random access memory 230 may be a buffer memory or a cache memory. The random access memory 230 may include a volatile or nonvolatile random access memory such as SRAM, DRAM, SDRAM, FRAM, PRAM, MRAM, and RRAM.

The host interface 240 may mediate communication with a host.

The ROM 250 is connected to the controller 220. The ROM 250 is configured to store a boot code BC and an update code UC. The boot code BC may include codes to initialize the memory 160/170 during booting of the memory 160/170. The boot code BC may include a code to load firmware FW stored in the nonvolatile memory 210 to the controller 220. The update code UC may include a code to update the firmware FW stored in the nonvolatile memory 210.

The controller 220 may receive a normal command an address through the host interface 240 and access the nonvolatile memory 210 according to the received normal command and the received address. The controller 220 may receive a normal command and an address depending on a predetermined or, alternatively, desired rule through the host interface 240 and update the firmware FW in response to the received normal command and the received address depending on the predetermined or, alternatively, desired rule. The controller 220 may stop running the firmware FW and execute the update code UC stored in the ROM 250 to update the firmware FW.

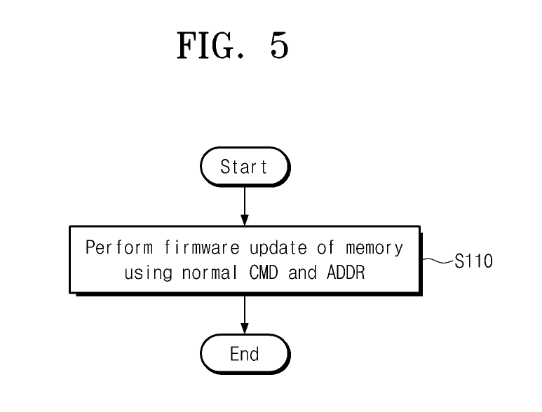

FIG. 5 is a flowchart summarizing a method of updating firmware of a memory 160/170 according to at least one example embodiment of the inventive concepts. Referring to FIGS. 1 to 5, firmware FW of the memory 160/170 is updated using a normal command and an address (S110).

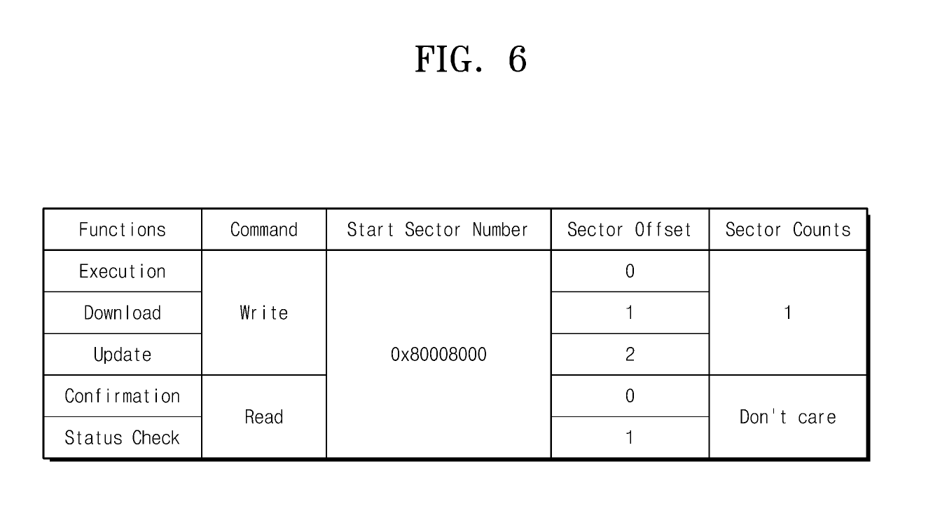

FIG. 6 is a table showing an example of a rule of a normal command and an address for updating firmware of a memory 160/170. As is illustrated in FIG. 6, read and write commands are examples of normal commands. Referring to FIG. 6, functions for firmware update include an execution function, a download function, an update function, a confirm function, and a state check function. The execution function may be a function to indicate an execution of a function issued to the memory 160/170. The download function may be a function to issue download (e.g., reception and storage) of update data for the update data to the memory 160/170. The update function may be a function to update the firmware using the update data. The confirm function may be a function to request a confirmation of what an issued function is. The state check function may be a function to request information on an operation state of the memory 160/170.

A command and an address may each be allocated to the function for firmware update. The address may include a start sector number, a sector offset, and a sector count.

A write command may be allocated to the execution function, the download function, and the update function. A read command may be allocated to the confirm function and the state check function. According to one or more example embodiments of the inventive concepts, a write command may be allocated to a function where there is information to be transmitted to the memory 160/170 from a host. A read command may be allocated to a function where there is information to be transmitted to the host from the memory 160/170.

The start sector number may be a standard for identifying the functions of the firmware update. For example, the start sector number may be a start sector number of a single cluster of the memory 160/170. The start sector number may be a start sector number of a file stored in the memory 160/170. The start sector number may be a start sector number of a dummy file generated for the firmware update. In the example illustrated in FIG. 6, let it be assumed that the start sector number is ‘0x80008000’.

The sector offset may indicate that a sector allocated to a selected function is an nth sector from a start sector. A sector offset allocated to the execution function and the confirm function may be ‘0’. Accordingly, the number of the sector allocated to the execution function and the confirm function may be ‘0x80008000’, which is the start sector number. A sector offset allocated to the download function and the state check function may be ‘1’. Accordingly, the number of a sector allocated to the execution function and the confirm function may be ‘0x80008001’, which is the next number of the start sector number. A sector offset allocated to the update function may be ‘2’. Accordingly, the number of a sector allocated to the update function may be ‘0x80008002’, which is a sector number after next of the start sector number.

A sector count of the execution function, the download function, and the update function may be 1. The confirm function and the state check function may be processed irrespective of a sector count.

As shown in FIG. 6, the host may transmit a normal command and an address to the memory 160/170 to issue a function associated with the firmware update. When the received normal command and the received address meet a predetermined or, alternatively, desired rule, the memory 160/170 may identify the received normal command and the received address as a function associated with the firmware update.

According to one or more example embodiments of the inventive concepts, both the host and the memory 160/170 may know the rule shown in FIG. 6 beforehand. According to one or more example embodiments of the inventive concepts, the host may read the rule shown in FIG. 6 from the memory 160/170 and use the read rule. The host may detect an identifier of the memory 160/170 and may remotely download a suitable rule for the memory 160/170.

In FIG. 6, detailed functions for executing the firmware update have been explained with reference to detailed commands and detailed addresses. However, one or more example embodiments of the inventive concepts are not limited to the functions shown in FIG. 6 and commands and addresses associated with the functions.

According to one or more example embodiments of the inventive concepts, functions for executing the firmware update may include an additional function other than the functions shown in FIG. 6, and some of the functions shown in FIG. 6 may not be used. Commands and addresses allocated to the functions for executing the firmware update are also not limited to the examples shown in FIG. 6. Since the commands and addresses allocated to the functions for executing the firmware update use normal commands and have differences enough to be distinguished from each other, they are not limited to the example shown in FIG. 6.

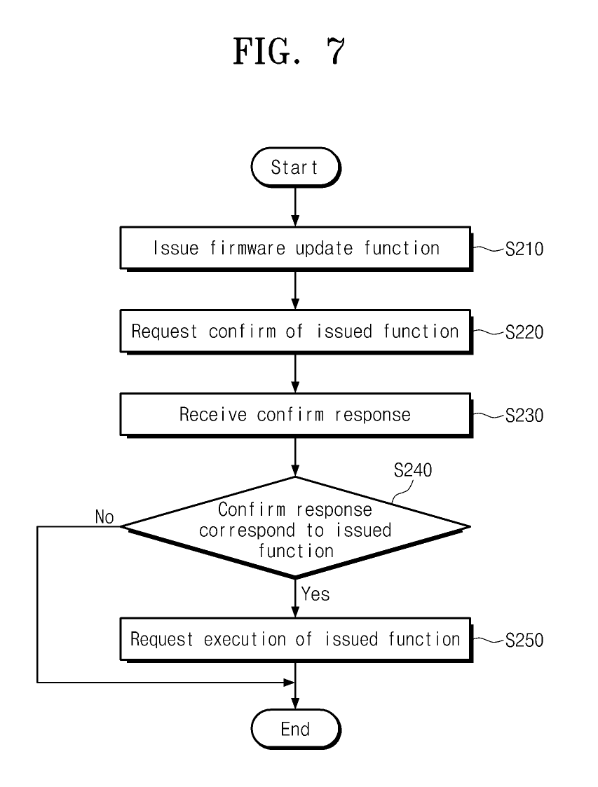

FIG. 7 is a flowchart summarizing the operation of a host when a firmware update is performed. Referring to FIGS. 1 to 4 and FIG. 7, a host may issue a firmware update function to the memory 160/170 (S210). For example, the host may transmit a write command, a write address, and write data satisfying the rule shown in FIG. 6 to the memory 160/170. For example, the write data may be dummy data.

The host may request a confirmation of the issued function to the memory 160/170 (S220). For example, the host may transmit a read command a read address satisfying the rule shown in FIG. 6 to the memory 160/170.

The host may receive a confirm response according to the confirmation request from the memory 160/170 (S230). For example, the host may receive read data according to the read command as the confirm response. For example, the host may recognize the read data according to the read command as the confirmation response and acknowledge an issued function using the read data.

The host determines whether the confirmation response received from the memory 160/170 corresponds to the issued function (i.e., function issued at S210) (S240). For example, the host may determine whether the memory 160/170 properly recognizes the issued function for the firmware update (i.e., function issued at S210).

When the confirmation response does not correspond to the issued function, i.e., the memory 160/170 does not properly recognize the issued function, the host may stop firmware update. In another embodiment, when the confirmation response does not correspond to the issued function, the host may restart the flow from S210.

When the confirmation response corresponds to the issued function, i.e., the memory 160/170 properly recognizes the issued function, the flow proceeds to S250. The host may request an execution of the issued function to the memory 160/170 in step S250. For example, the host transmits a write command, a write address, and write data satisfying the rule shown in FIG. 6 to the memory 160/170. The write data may include update data for the firmware update.

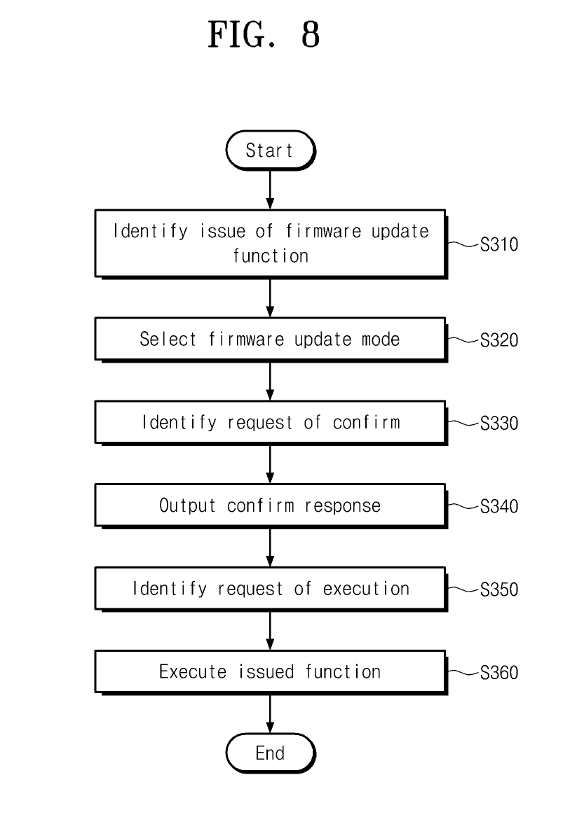

FIG. 8 is a flowchart summarizing the operation of a memory when firmware update is performed. Referring to FIGS. 1 to 4 and FIG. 7, the memory 160/170 may identify an issuance of a command to perform a firmware update function (S310). For example, the memory 160/170 may receive a write command, a write address, and write data corresponding to a command to perform a firmware update function. The memory 160/170 may identify that the issue of the command to perform the firmware update function is received, based on the write command and the write address satisfying the rule shown in FIG. 6. The write data may be dummy data. The memory 160/170 may neglect the write data.

The memory 160/170 selects a firmware update mode (S320). The memory 160/170 may select and prepare the firmware update mode. For example, the memory 160/170 may execute codes for firmware update among codes of firmware driven by the controller 220. For example, the memory 160/170 may execute the update code UC stored in the ROM 250.

The memory 160/170 may identify whether confirmation of the issued function is requested (S330). For example, the memory 160/170 receives a read command and a read address. Based on the received read command and the received read address satisfying the rule shown in FIG. 6, the memory 160/170 may identify whether the confirmation request of the issued function is received.

The memory 160/170 outputs a confirmation response (S340). The confirmation response may not be data stored in sectors corresponding to the read address. For example, the memory 160/170 may generate the confirmation response such that the confirmation response includes information regarding the command to perform a firmware update function identified at S310, which the host will recognize as a confirmation response indicating proper receipt of the command to perform the firmware update function.

The memory 160/170 may identify whether an execution of the issued function is requested (S350). For example, the memory 160/170 receives a write command, a write address, and write data. The memory 160/170 may identify that an execution request of the issued function is received, based on the write command the write address satisfying the rule shown in FIG. 6. The write data may include update data for the firmware update.

The memory 160/170 executes the issued function (S360). For example, the memory 160/170 may execute a function to store update data received as write data (e.g., download function). For example, the memory 160/170 may execute a function to update firmware using the update data received as write data or predetermined or, alternatively, desired update data (e.g., update function).

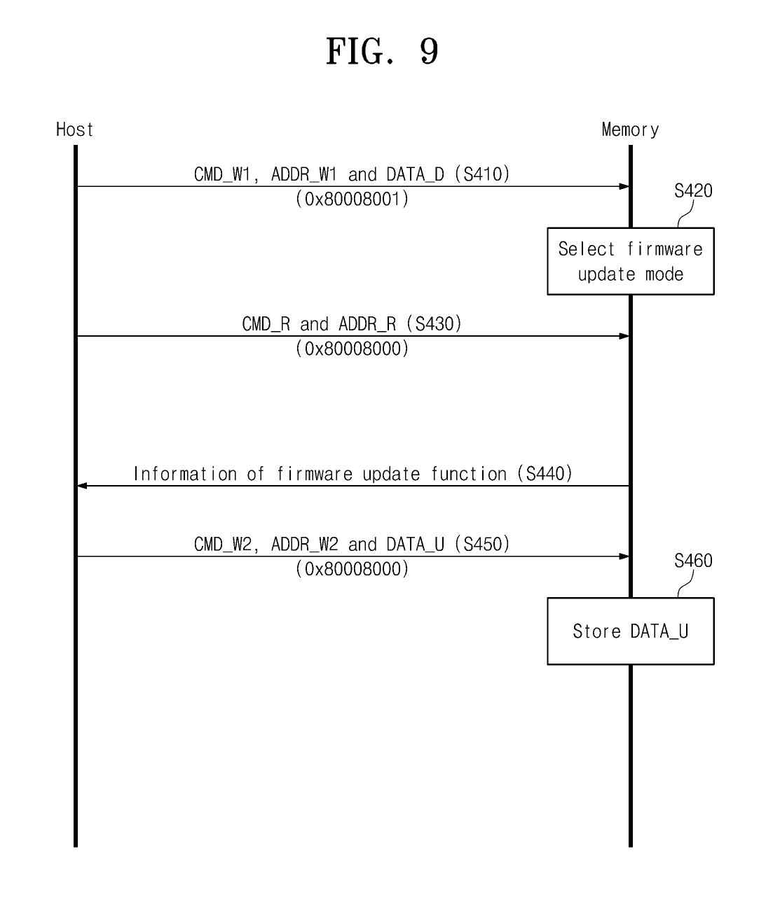

FIG. 9 is a flowchart summarizing a method of performing a download function of firmware. Referring to FIGS. 1 to 4, FIG. 6, and FIG. 9, the host may transmit a first write command CMD_W1, a first write address ADDR_W1, and dummy data DATA_D to the memory 160/170 (S410). The host may transmit the value ‘0x80008001’ allocated to the download function as the first write address ADDR_W.

The memory 160/170 may identify that a firmware download function has been issued, based on the first write command CMD_W1 and the first write address ADDR_W1 (0x80008001) (S420). The memory 160/170 may select a firmware update mode. The firmware update mode may be a mode in which various functions associated with firmware update are executed.

The host may transmit a read command CMD_R and a read address ADDR_R to the memory 160/170 (S430). The host may transmit the value ‘0x80008000’ allocated to the confirm function as the read address ADDR_R.

The memory 160/170 may output information on the issued function, i.e., the download function to the host (S440).

The host transmits a second write command CMD_W2, a second write address ADDR_W2, and update data DATA_U to the memory 160/170. The host may transmit the ‘0x80008000’ allocated to the execution function as the second write address ADDR_W2 (S450).

The memory 160/170 may store the update data DATA_U (S460), for example, in response to the second write command CMD_W2 issued in step S450.

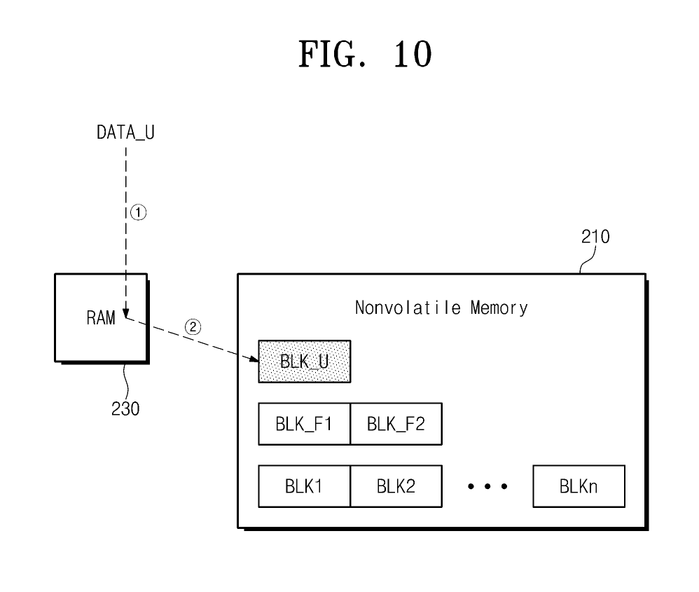

FIG. 10 illustrates an example where a memory 160/170 stores update data DATA_U when a download function is performed. For brevity of description, among components of the memory 160/170, only a nonvolatile memory 210 and a random access memory (RAM) 230 are shown in FIG. 10. Referring to FIGS. 1 to 4 and FIG. 10, the update data DATA_U may be stored in the RAM 230.

If the memory 160/170 is an MMC or an eMMC, capacity of the RAM 230 may not be high enough to store the update data DATA_U. Accordingly, the memory 160/170 may store the update data DATA_U stored in the RAM 230 in the nonvolatile memory 210 immediately.

The nonvolatile memory 210 may include a plurality of memory blocks BLK BLK1˜BLKn, BLK_F1, BLK_F2, and BLK_U. For example, the nonvolatile memory 210 may include memory blocks BLK1 to BLKn to store user data, firmware memory blocks BLK_F1 and BLK_F2 to store firmware FW, and a firmware update memory block BLK_U to store update data DATA_U. According to one or more example embodiments of the inventive concepts, the memory blocks BLK1 to BLKn may be identified and accessed by the host. According to one or more example embodiments of the inventive concepts, the firmware memory blocks BLK_F1 and BLK_F2 may not be identified by the host. According to one or more example embodiments of the inventive concepts, the firmware memory blocks BLK_F1 and BLK_F2 are designated to store only firmware FW. The firmware memory block BLK_F2 may store a copy of data of the firmware memory block BLK_F1. According to one or more example embodiments of the inventive concepts, the firmware update memory block BLKL_U may not be identified by the host. According to one or more example embodiments of the inventive concepts, the firmware update memory block BLK_U may be designated to store only update data DATA_U. The nonvolatile memory 210 may be erased, for example, in units of memory blocks. Data stored in a memory block may be erased, for example, simultaneously. A memory block may include a plurality of read/write units.

The memory 160/170 may transfer the update data DATA_U stored in the RAM 230 to the firmware update memory block BLK_U. That is, the memory 160/170 may download the update data DATA_U to the firmware update memory block BLK_U of the nonvolatile memory 210 by using the RAM 230 as a buffer memory.

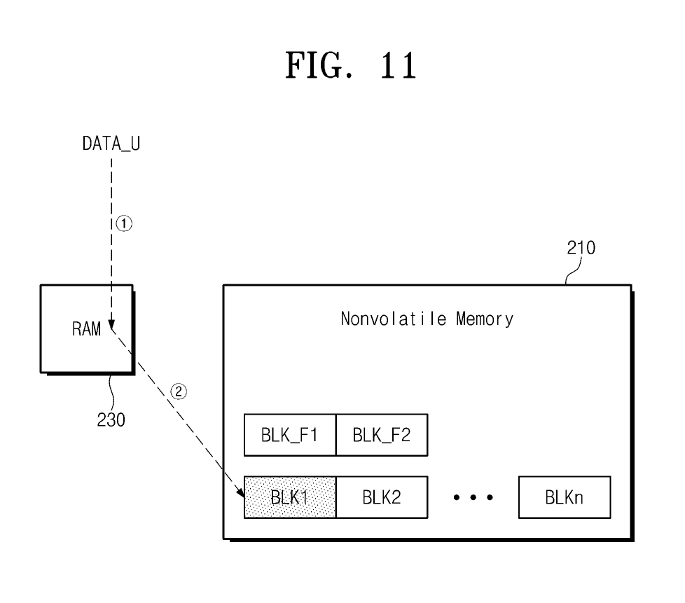

FIG. 11 illustrates another example where a memory 160/170 stores update data DATA_U when a download function is performed. For brevity of description, among components of the memory 160/170, only a nonvolatile memory 210 and a random access memory (RAM) 230 are shown in FIG. 11. Referring to FIGS. 1 to 4 and FIG. 11, the update data DATA_U may be stored in the RAM 230.

The nonvolatile memory 210 may include memory blocks BLK1 to BLKLn to store user data and firmware memory blocks BLK_F1 and BLK_F2 to store firmware.

The memory 160/170 may store the update data DATA_U stored in the RAM 230 in a free memory block (e.g., BLK1) among the memory blocks BLK1 to BLKn. That is, the memory 160/170 may download the update data DATA_U in the free memory block BLK1 of the nonvolatile memory 210 by using the RAM 230 as a buffer memory.

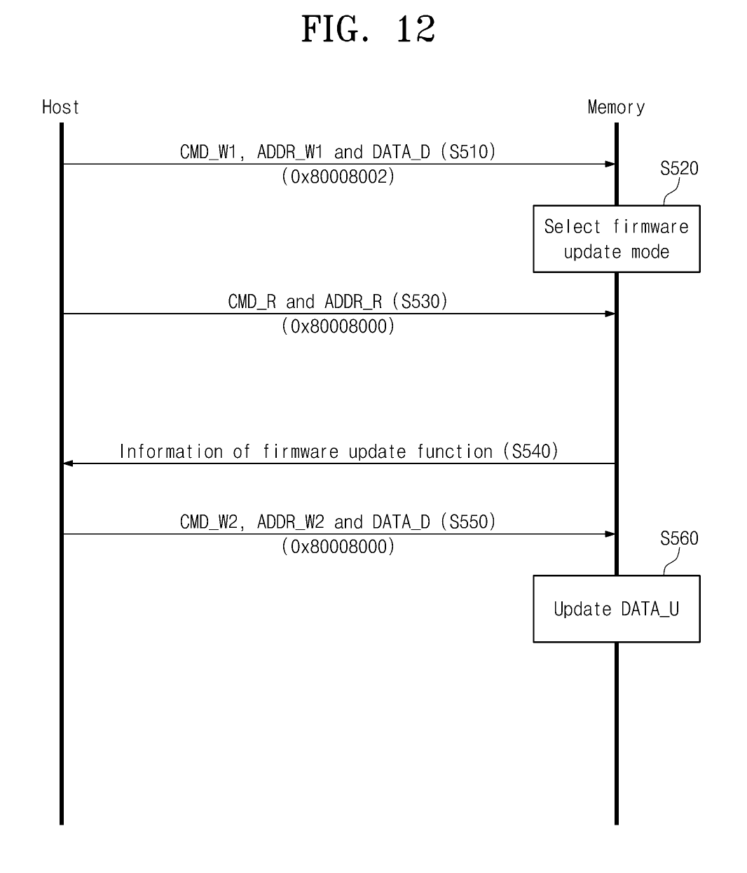

FIG. 12 is a flowchart summarizing a method of performing a update function. Referring to FIGS. 1 to 4, FIG. 6, and FIG. 12, the host may transmit a first write command CMD_W1, a first write address ADDR_W1, and dummy data DATA_D to the memory 160/170 (S510). The host may transmit the value ‘0x80008002’ allocated to the update function as the first write address ADDR_W1.

The memory 160/170 may identify that the firmware update function has been issued, based on the first write command CMD_W1 and the first write address ADDR_W1 (0x80008001) (S520). The memory 160/170 may select a firmware update mode.

The host may transmit a read command CMD_R and a read address ADDR_R to the memory 160/170 (S530). The host may transmit the value ‘0x80008000’ allocated to a confirm function as the read address ADDR_R.

The memory 160/170 may output information on the issued function, i.e., the update function to the host (S540).

The host transmits a second write command CMD_W2, a second write address ADDR_R2, and dummy data DATA_D to the memory 160/170 (S550). The host may transmit the value ‘0x80008000’ allocated to an execution function as the second write address ADDR_W2.

The memory 160/170 executes firmware update using the update data DATA_U (S560). For example, the memory 160/170 may perform the firmware update using the update data DATA_U previously stored in the memory 160/170 through a download function.

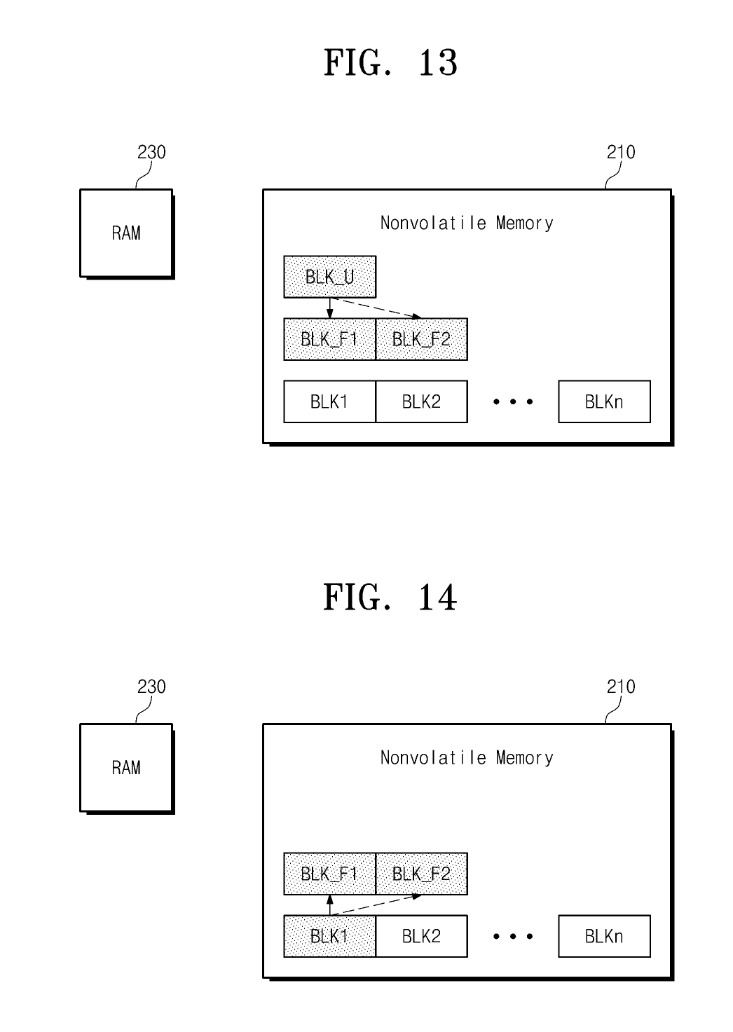

FIG. 13 illustrates an example where a memory 160/170 updates firmware when an update function is performed. For brevity of description, among components of the memory 160/170, only a nonvolatile memory 210 and a random access memory (RAM) 230 are shown in FIG. 13. Referring to FIGS. 1 to 4 and FIG. 13, the nonvolatile memory 210 may include memory blocks BLK1 to BLKn to store user data, firmware memory blocks BLK_F1 and BLK_F2 to store firmware, and a firmware update memory block BLK_U to store update data DATA_U. According to one or more example embodiments of the inventive concepts, the update data DATA_U may be previously stored in the firmware update memory block BLK_U. For example, the update data DATA_U may be previously stored in the firmware update memory block BLK_U according to the method described with reference to FIG. 10.

The memory 160/170 may copy the update data DATA_U stored in the firmware update memory block BLK_U to the firmware memory blocks BLK_F1 and BLK_F2. For example, according to one or more example embodiments of the inventive concepts, the memory 160/170 may erase the firmware memory blocks BLK_F1 and BLK_F2, read the update data DATA_U from the firmware update memory block BLK_U, and write the update data DATA_U into the firmware memory blocks BLK_F1 and BLK_F2.

After the update data DATA_U are written into the firmware memory blocks BLK_F1 and BLK_F2, the memory 160/170 may be rebooted. When the memory 160/170 is rebooted, the memory 160/170 may read updated firmware from the firmware memory blocks BLK_F1 and BLK_F2 and execute the updated firmware.

FIG. 14 illustrates another example where a memory 160/170 updates firmware when an update function is performed. For brevity of description, among components of the memory 160/170, only a nonvolatile memory 210 and a random access memory (RAM) 230 are shown in FIG. 14. Referring to FIGS. 1 to 4 and FIG. 14, the nonvolatile memory 210 may include memory blocks BLK1 to BLKn to store user data and firmware memory blocks BLK_F1 and BLK_F2 to store firmware. The update data DATA_U may be previously stored in one (e.g., BLK1) of the memory blocks BLK1 to BLKn. For example, the update data DATA_U may be previously stored in the memory block BLK1 according to the method described with reference to FIG. 11.

The memory 160/170 may copy the update data DATA_U stored in the memory block BLKL1 to the firmware memory blocks BLK1 and BLK2. According to one or more example embodiments of the inventive concepts, the memory 160/170 may erase the firmware memory blocks BLK_F1 and BLK_F2, read the update data DATA_U from the memory block BLK1, and write the update data DATA_U into the firmware memory blocks BLK_F1 and BLK_F2.

After the update data DATA_U are written into the firmware memory blocks BLK_F1 and BLK_F2, the memory 160/170 may be rebooted.

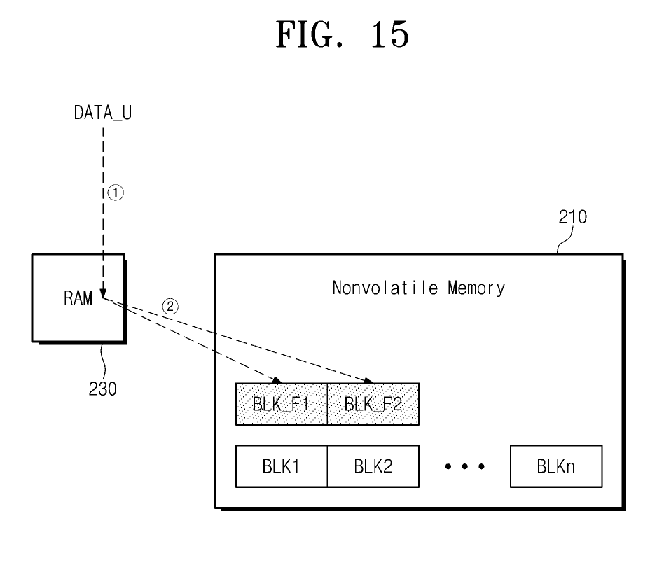

FIG. 15 illustrates another example where a memory 160/170 updates firmware when an update function is performed. For brevity of description, among components of the memory 160/170, only a nonvolatile memory 210 and a random access memory (RAM) 230 are shown in FIG. 15. Referring to FIGS. 1 to 4 and FIG. 15, the nonvolatile memory 210 may include memory blocks BLK1 to BLKn to store user data and firmware memory blocks BLK_F1 and BLK_F2 to store firmware. The RAM may have capacity enough to store the update data DATA_U.

The update data DATA_U transmitted from the host may be stored in the RAM 230. After the update data DATA_U are all stored in the RAM 230, firmware may be updated using the update data DATA_U stored in the RAM 230. According to one or more example embodiments of the inventive concepts, the memory 160/170 may erase the firmware memory blocks BLK_F1 and BLK_F2, read the update data DATA_U from the RAM 230, and write the update data DATA_U into the firmware memory blocks BLK_F1 and BLK_F2.

After the update data DATA_U is written into the firmware memory blocks BLK_F1 and BLK_F2, the memory 160/170 may be rebooted.

According to one or more example embodiments of the inventive concepts, the update method of FIG. 15 may be performed in response to the download function explained with reference to FIG. 9. In other embodiments, the update method of FIG. 15 may be performed in response to the update function explained with reference to FIG. 12, in which case, the update data DATA_U may be transmitted together with the second write command CMD_W2 and the second write address ADDR_W2 (S550).

According to one or more example embodiments of the inventive concepts, depending on whether the capacity of the RAM 230 in the memory 160/170 is enough to store the update data DATA_U, the host may issue firmware update according to the method described with reference to FIGS. 10, 11, 13, and 14 or the method described with reference to FIG. 15. Depending on whether the capacity of the RAM 230 in the memory 160/170 is enough to store the update data DATA_U, the memory 160/170 may perform firmware update according to the method described with reference to FIGS. 10, 11, 13, and 14 (e.g., when the capacity is not enough) or the method described with reference to FIG. 15 (when that the capacity is enough).

In example described above, a download function and an update function are described as being separately performed when the capacity of the RAM 230 is not enough to store the update data DATA_U. However, commands to perform the download function and the update function may be issued at the same time even when the capacity of the RAM 230 is not enough to store the update data DATA_U. For example, the host may issue the firmware update function to the memory 160/170. In response to the issued firmware update function, the memory 160/170 may download the update data DATA_U and update firmware using the downloaded update data DATA_U. According to one or more example embodiments of the inventive concepts, the update data DATA_U may be streamed for the firmware update.

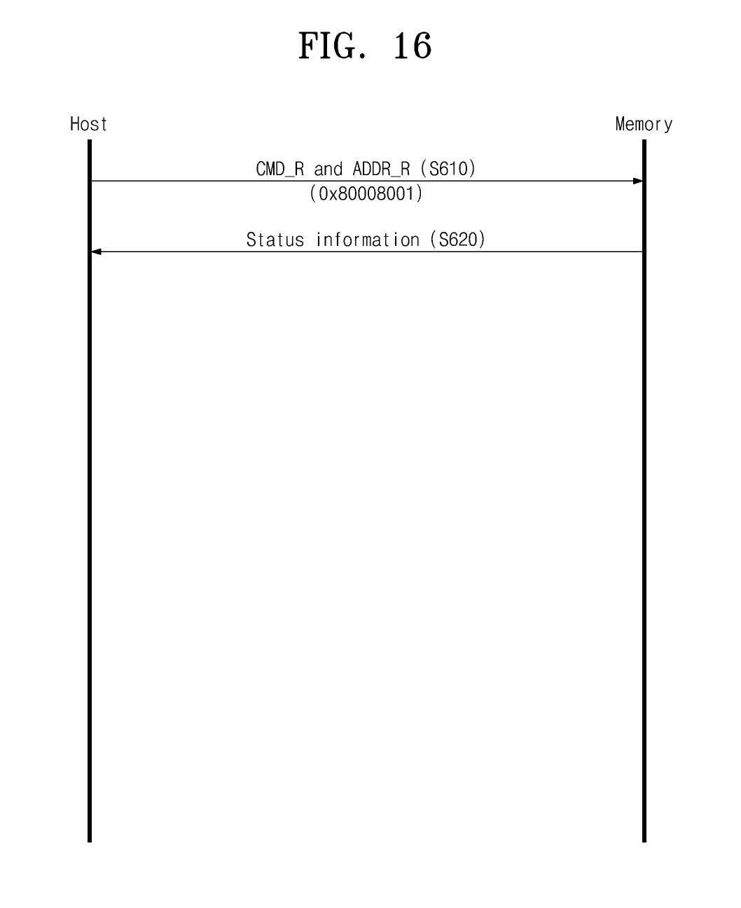

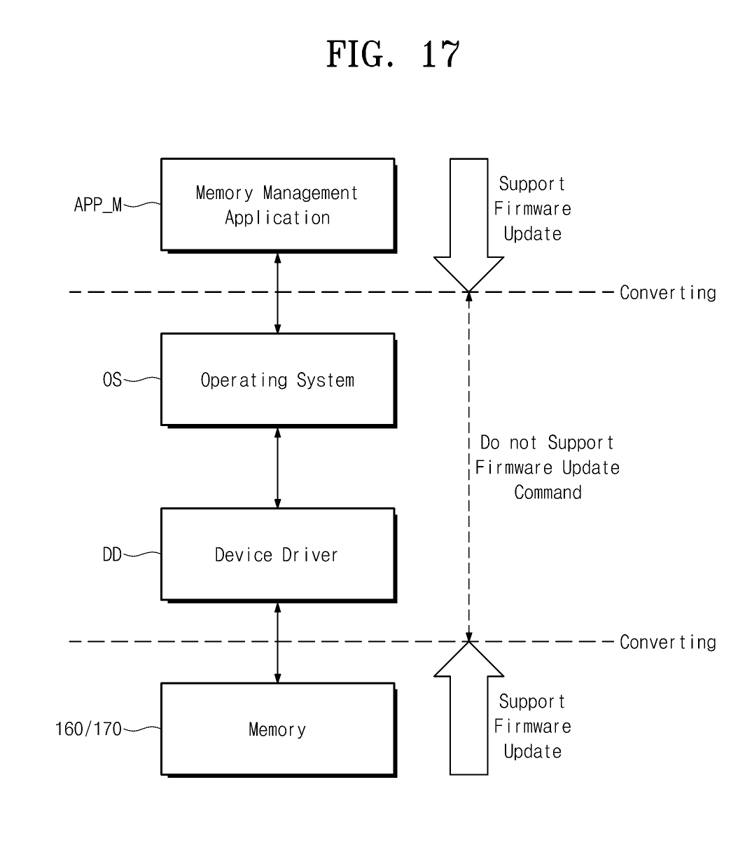

FIG. 16 is a flowchart summarizing a method of performing a state check function. Referring to FIGS. 1 to 4, FIG. 6, and FIG. 16, the host transmits a read command CMD_R and a read address ADDR_R to the memory 160/170 (S610). For example, the value ‘0x80008001’ allocated to a state check function may be transmitted by the host to the memory 160/170 as the read address ADDR_R.

The memory 160/170 may transmit state information to the host. The state information may include, for example, information indicating whether an issued function for firmware update is completed, information on a result of the issued function, and the like.

By using the state check function, the host may identify whether the memory 160/170 has completed an issued function or whether the memory 160/170 is ready for performing another function (e.g., a normal operation or another function for the firmware update).

FIG. 17 is a block diagram of a software layer according to at least one example embodiment of the inventive concepts. Referring to FIG. 17, a memory management application APP_M may run on an operating system OS. The memory management application APP_M may be management software to improve or, alternatively, optimize operating performance of the memory 160/170 and enhance reliability of the memory 160/170. The memory management application APP_M may support a function to update firmware of the memory 160/170.

When firmware update of the memory 160/170 is required or, alternatively, desired, the memory management APP_M may transfer a firmware update function after converting the firmware update function into a normal command and an address according to the methods described with reference to FIGS. 5 to 16 and a predetermined or, alternatively, desired rule.

According to one or more example embodiments of the inventive concepts, the operating system OS may not grant root privilege to the memory management application APP_M. Further, according to one or more example embodiments of the inventive concepts, the operating system OS may grant the root privilege to the memory management application APP_M, but the memory 160/170 may be connected through a reader 180 which has limited abilities to transfer commands as is described above with reference to FIG. 3. Accordingly, the operating system OS and a device driver DD may not support a firmware update command.

A firmware update function is transferred, for example, by the host. after being converted into a normal command and an address. Accordingly, even in a scenario where the operating system OS grants the root privilege to the memory management application APP_M and the memory is connected through the reader 180, the firmware update function required by the memory management application APP_M may be transferred to the memory 160/170 as a normal command and an address.

The memory 160/170 may extract the firmware update function from the normal command and address. For example, the memory 160/170 may translate the normal command and address into the firmware update function based on the rules illustrated in FIG. 6. The memory 160/170 may perform firmware update according to the extracted firmware update function.

According to embodiments of the inventive concept, although there is a hierarchy to support only a normal command between the applications APP_M and the memory 160/170, the application APP_M may issue firmware update to the memory 160/170. Thus, a method of operating a memory device including a memory and a memory controller with improved operating performance is provided.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A method of updating firmware of a memory device including a memory and a controller driving firmware to control the memory, the method comprising:
updating the firmware of the memory device by transmitting at least one normal command and an address corresponding to the at least one normal command to the memory device,
wherein the normal command is a command to issue a normal operation, and
wherein the normal operation is not an update operation of the firmware.

2. The method as set forth in claim 1, wherein the normal command is a read or write command, and the normal operation is a read or write operation depending on the read or write command.

3. The method as set forth in claim 1, wherein the address has a value corresponding to a rule for updating the firmware.

4. The method as set forth in claim 1, wherein the updating the firmware of the memory device comprises:
transmitting a first normal command and a first address to the memory device, the first normal command and the first address corresponding to a request for the memory device to download update data; and
transmitting a second normal command and a second address to the memory device, the second normal command and the second address corresponding to a request for the memory device to update the firmware.

5. The method as set forth in claim 4, wherein the updating the firmware of the memory device further comprises:
transmitting a third normal command and a third address to the memory device, the third normal command and the third address corresponding to a request for the memory device to confirm that the first normal command and the first address were properly received by the memory device; and
transmitting a fourth normal command and a fourth address to the memory device, the fourth normal command and the fourth address corresponding to a request for the memory device to confirm that the second normal command and the second address were properly received by the memory device.

6. The method as set forth in claim 4, wherein the updating the firmware of the memory device further comprises:
transmitting a third normal command and a third address to the memory device together with the update data, the third normal command and the third address corresponding to a request for the memory device to start downloading the update data; and
transmitting a forth normal command and a fourth address to the memory device, the fourth normal command and the fourth address corresponding to a request for the memory device to start updating the firmware.

7. The method as set forth in claim 1, further comprising:
transmitting a second normal command and a second address to the memory device, the second normal command and the second address corresponding to a request for the memory device to send information regarding an update progress status of the firmware.

8. A method of updating firmware of a memory device including a memory and a controller driving firmware to control the memory, the method comprising:
receiving, at the memory device, at least one normal command and an address corresponding to the at least one normal command of the memory device;
updating the firmware in response to the memory device receiving the at least one normal command and the address,
wherein the normal command is a command to perform a normal operation, and
wherein the normal operation is not an operation of updating the firmware.

9. The method as set forth in claim 8, wherein the updating the firmware comprises:
storing update data of the firmware in a buffer memory of the memory device; and
updating the firmware using the update data stored in the buffer memory.

10. The method as set forth in claim 8, wherein the updating the firmware comprises:
storing update data of the firmware in a memory block of the memory through a buffer memory of the memory device; and
updating the firmware using the update data stored in the memory block.

11. The method as set forth in claim 10, wherein the memory block is a block allocated to store the update data, and the memory block does not store user data.

12. The method as set forth in claim 10, wherein the memory block is a free block among a plurality of memory blocks, the plurality of memory blocks being designated for storing user data.

13. The method as set forth in claim 8, wherein the firmware is stored in at least two memory blocks among a plurality of memory blocks of the memory, the at least two memory blocks being blocks that do not store user data.

14. The method as set forth in claim 13, wherein the updating the firmware comprises:
erasing the at least two memory blocks; and
writing update data of the firmware into the at least two of the memory blocks.

15. The method as set forth in claim 8, further comprising:
rebooting the memory device after update of the firmware is completed.

16. A method of updating firmware of a memory device including a memory and a controller that executes firmware to control the memory device, the method comprising:
receiving, at the memory device, at least one first command and a first address corresponding to the at least one first command, the first command having a format for instructing the memory device to perform a first operation;
determining whether the at least one first command and the first address satisfy one of a plurality of rules;
when the at least one first command and the first address satisfy one of the plurality of rules,
performing, in response to receiving the at least one first command and the first address, a firmware update operation instead of performing the first operation,
the firmware update operation including updating the firmware of the memory device,
the first operation being different from the firmware update operation.

17. The method of claim 16 further comprising:
storing, in the memory device, rules information defining the first plurality of rules, the rules information indicating one or more addresses,
wherein the determining includes,
performing a comparison operation based on the first address and the one or more addresses indicated by the rules information, and
determining whether the at least one first command and the first address satisfy one of a plurality of rules based on the comparison.

18. The method of claim 16 wherein,
the first operation is a read operation for instructing the memory device to read information from a location in the memory device that is specified by an address sent with the at least one first command, or
the first operation is a write operation for instructing the memory device to write information at a location in the memory device that is specified by an address sent with the at least one first command.
